(19) United States
(12) Patent Application Publication
(10) Pub. No.: US 2022/0260682 A1
(43) Pub. Date: Aug. 18, 2022

(54) LENS FOR LIDAR ASSEMBLY

(71) Applicant: Continental Automotive Systems, Inc., Auburn Hills, MI (US)

(72) Inventors: Chad S Wang, Santa Barbara, CA (US); Pushkar P Pandit, Cupertino, CA (US)

(73) Assignee: Continental Automotive Systems, Inc., Auburn Hills, MI (US)

(21) Appl. No.: 17/249,015

(22) Filed: Feb. 17, 2021

(51) Int. Cl. G01S 7/481; G01S 17/931; G01S 17/89

(52) U.S. Cl. CPC G01S 7/4811; G01S 17/89; G01S 17/931; G01S 7/4817

(57) ABSTRACT

A lidar assembly includes a light emitter, a light detector, and a lens positioned to project light from the light emitter. The lens is polycarbonate. The lens has a light-absorbing dye in the polycarbonate that absorbs light having a first wavelength and transmits light at wavelengths greater than and/or less than the first wavelength.

### BACKGROUND

A lidar system includes a photodetector, or an array of photodetectors. Light is emitted into a field of view of the photodetector. The photodetector detects light that is reflected by an object in the field of view. For example, a flash lidar system emits pulses of light, e.g., laser light, into essentially the entire the field of view. The detection of reflected light is used to generate a 3D environmental map of the surrounding environment. The time of flight of the reflected photon detected by the photodetector is used to determine the distance of the object that reflected the light.

The lidar system may be mounted on a vehicle to detect objects in the environment surrounding the vehicle and to detect distances of those objects for environmental mapping. The output of the lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

Some applications, e.g., in a vehicle, include several lidar systems. For example, the multiple system may be aimed in different directions and/or may detect light at different distance ranges, e.g., a short range and a long range.

### BRIEF DESCRIPTION OF THE DRAWINGS

FIG. 1 is a perspective view of a vehicle having a lidar system.

FIG. 2 is a perspective view of the lidar system.

FIG. 3 is a cross section of the lidar system.

FIG. 4 is a perspective view of components of a light-receiving system of the lidar system.

FIG. 4A is an enlarged illustration of a portion of FIG. 4.

FIG. 5 is a block diagram of components of the vehicle and the lidar system.

FIG. 6 is a perspective view of a lens, specifically a diffuser, of the lidar system diffusing light emitted by a light emitter of the lidar system.

FIG. 7 is an example graph showing transmission of light by light-absorbing dye in the lens at various wavelengths of light.

### DETAILED DESCRIPTION

With reference to the Figures, wherein like numerals indicate like parts throughout the several views, a lidar assembly 20 includes a light emitter 22, a light detector 25, and a lens 44 positioned to project light from the light emitter 22 into a field of view of the light detector 25. The lens 44 is polycarbonate. The lens 44 has a light-absorbing dye in the polycarbonate that absorbs light having a first wavelength and transmits light at wavelengths greater than and/or less than the first wavelength.

The light emitter 22 may emit light at two different wavelengths, one being a desired wavelength and the other being an undesired wavelength. The lens 44 prevents the light at the undesired wavelength from exiting the lidar system 20. Specifically, the light-absorbing dye in the polycarbonate absorbs the light at the undesired wavelength. For example, the lens 44 may be designed so that the first wavelength described above at which the light-absorbing dye absorbs light is the same as the undesired wavelength of light emitted by the light emitter 22. Accordingly, the lens 44 absorbs the light at the first wavelength, i.e., the undesired wavelength, emitted by the light emitter 22 and prevents the light having the undesired wavelength from exiting the lidar system 20.

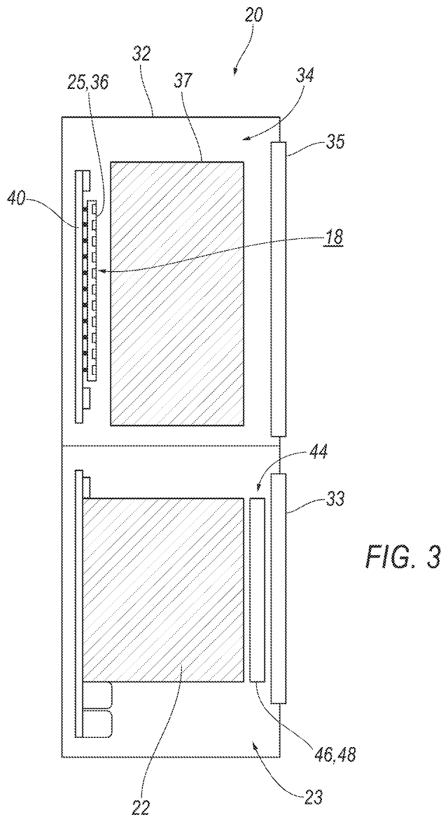

As described further below, the lens may be internal to the lidar system 20, e.g., may be an optical element that shapes, directs, and/or transmits light emitted by the light emitter 22. One such example of an optical element 46 is shown in FIG. 3. Specifically, the optical element 46 is a diffuser 48 in the example in FIG. 3. As another example, the lens may be the outer window 33 of the lidar system 20 through which light exits the lidar system 20. In FIG. 3, merely by way of example, the diffuser 48 is identified with reference numeral 44 identifying it as lens 44; it should be appreciated that in the example of FIG. 3, in the alternative to or in addition to the diffuser 48 being the lens 44 that is polycarbonate with the light-absorbing dye, the outer window 33 may be the lens 44 that is polycarbonate with the light-absorbing dye.

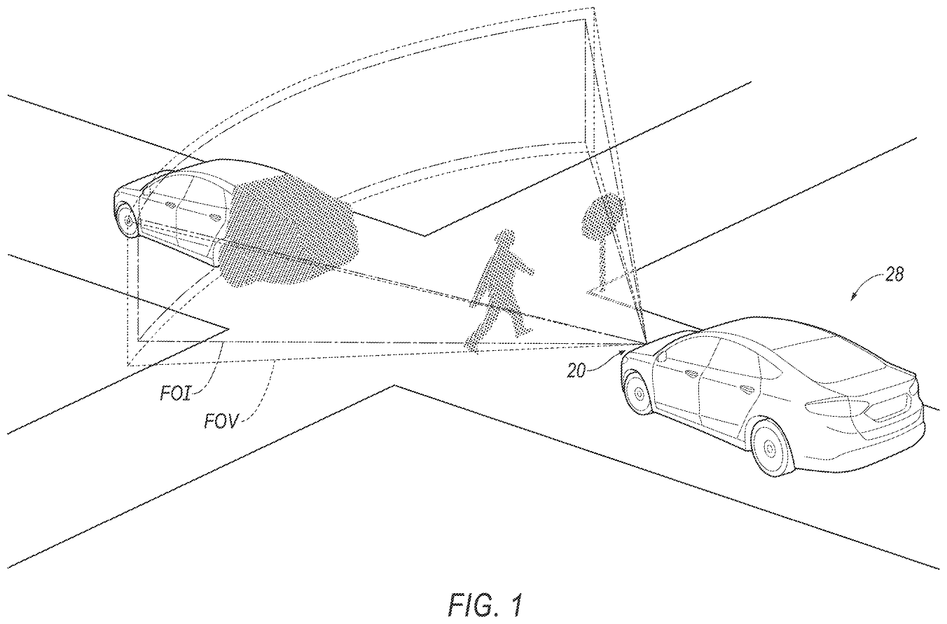

FIG. 1 shows an example vehicle 28. The lidar system 20 is mounted to the vehicle 28. In such an example, the lidar system 20 is operated to detect objects in the environment surrounding the vehicle 28 and to detect distances of those objects for environmental mapping. The output of the lidar system 20 may be used, for example, to autonomously or semi-autonomously control the operation of the vehicle 28, e.g., propulsion, braking, steering, etc. Specifically, the lidar system 20 may be a component of or in communication with an advanced driver-assistance system (ADAS) 30 of the vehicle 28. The lidar system 20 may be mounted on the vehicle 28 in any suitable position and aimed in any suitable direction. As one example, the lidar system 20 is shown on the front of the vehicle 28 and directed forward. The vehicle 28 may have more than one lidar system 20 and/or the vehicle 28 may include other object detection systems, including other lidar systems 20. The vehicle 28 is shown in FIG. 1 as including a single lidar system 20 aimed in a forward direction merely as an example. The vehicle 28 shown in the Figures is a passenger automobile. As other examples, the vehicle 28 may be of any suitable manned or un-manned type including a plane, satellite, drone, watercraft, etc.

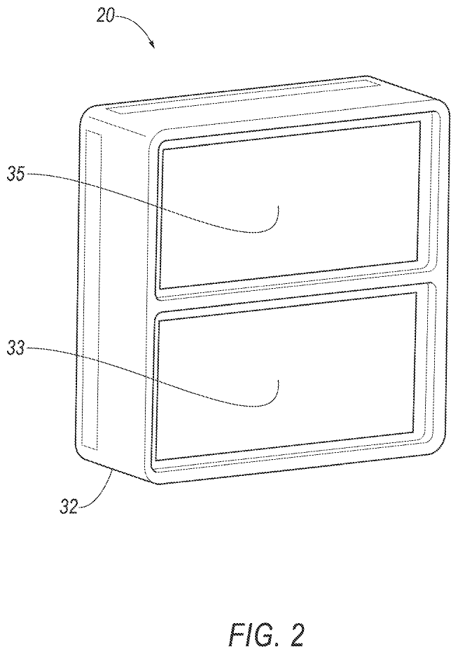

The lidar system 20 may be a solid-state lidar system 20. In such an example, the lidar system 20 is stationary relative to the vehicle 28. For example, the lidar system 20 may include a casing 32 (shown in FIG. 2 and described below) that is fixed relative to the vehicle 28, i.e., does not move relative to the component of the vehicle 28 to which the casing 32 is attached, and internal electronic components of the lidar system 20 are supported by the casing 32.

As a solid-state lidar system, the lidar system 20 may be a flash lidar system. In such an example, the lidar system 20 emits pulses of light into the field of illumination FOI (FIG. 1). More specifically, the lidar system 20 may be a 3D flash lidar system 20 that generates a 3D environmental map of the surrounding environment, as shown in part in FIG. 1. An example of a compilation of the data into a 3D environmental map is shown in the FOV and the field of illumination (FOI) in FIG. 1. A 3D environmental map may include location coordinates of points within the FOV with respect to a coordinate system, e.g., a Cartesian coordinate system with an origin at a predetermined location such as a GPS (Global Positioning System) reference location, or a reference point within the vehicle 28, e.g., a point where a longitudinal axis and a lateral axis of the vehicle 28 intersect.

In such an example, the lidar system 20 is a unit. With reference to FIGS. 2 and 3, the lidar system 20 may include the casing 32, an outer window 33, a light receiving system 34, and a light emitting system 23. In such an example, the casing 32 supports the light emitter 22 and the light detector 25, as shown in FIG. 3.

The casing 32, for example, may be plastic or metal and may protect the other components of the lidar system 20 from environmental precipitation, dust, etc. In the alternative to the lidar system 20 being a unit, components of the lidar system 20, e.g., the light emitting system 23 and the light receiving system 34, may be separate and disposed at different locations of the vehicle 28. The lidar system 20 may include mechanical attachment features to attach the casing 32 to the vehicle 28 and may include electronic connections to connect to and communicate with electronic system of the vehicle 28, e.g., components of the ADAS.

The outer window 33 allows light to pass through, e.g., light generated by the light emitting system 23 exits the lidar system 20 and/or light from environment enters the lidar system 20. The outer window 33 receives light from the light emitter 22 and transmits the light exterior to the casing 32. In other words, the outer window 33 may be referred to as an exit window. The outer window 33 protects an interior of the lidar system 20 from environmental conditions such as dust, dirt, water, etc. The outer window 33 may be a transparent or semi-transparent material, e.g., glass, plastic. The outer window 33 may extend from the casing 32 and/or may be attached to the casing 32.

With reference to FIGS. 1-3, the lidar system 20 includes the light emitter 22 that emits shots, i.e., pulses, of light into the field of illumination FOI for detection by a light-receiving system 34 when the light is reflected by an object in the field of view FOV. The light-receiving system 34 has a field of view (hereinafter “FOV”) that overlaps the field of illumination FOI and receives light reflected by surfaces of objects, buildings, road, etc., in the FOV. The light emitter 22 may be in electrical communication with a controller 26 of the lidar system 20, e.g., to provide the shots in response to commands from the controller 26.

The light emitter 22 may be a semiconductor light emitter, e.g., laser diodes. In one example, as shown in FIG. 3, the light emitter 22 may include a diode-pumped solid-state laser (DPSSL) emitter. In an example in which the light emitter 22 is a diode-pumped solid-state laser, the light emitter 22 may be an Nd:YAG laser. As another example, the light emitter 22 may be a fiber laser. As another example, the light emitter 22 may include a vertical-cavity surface-emitting laser (VCSEL) emitter. As another example, the light emitter 22 may include an edge emitting laser emitter. The light emitter 22 may be designed to emit a pulsed flash of light, e.g., a pulsed laser light. Specifically, the light emitter 22 is designed to emit a pulsed laser light. In any event, the light emitter 22 emits light at two wavelengths as described herein. Each pulsed flash of light may be referred to as the “shot” as used herein. The lidar system 20 may include any suitable number of light emitters 22. In examples that include more than one light emitter 22, the light emitters 22 may be identical or different.

The light emitted by the light emitter 22 may be infrared light. The light emitter 22 may emit light having two or more different wavelengths. The light emitter 22 may simultaneously emit light having two or more different wavelengths. As described further below, the lens 44 absorbs light having at least one of the wavelengths emitted by the light emitter. For example, in the example in which the light emitter 22 is an Nd:YAG laser, the light emitter 22 may emit light having a wavelength of between 750 nm and light having a wavelength between 1000-1100 nm. Specifically, the Nd:YAG laser may emit light having a wavelength of 808 nm and light having a wavelength of 1064nm. Alternatively, the light emitted by the light emitter 22 may be of any suitable wavelength.

With reference to FIG. 3, the light emitting system 23 may include one or more optical elements 46. The optical element 46 may be of any suitable type that shapes and/or directs light from the light emitter 22 toward the outer window 33. The optical element 46 is transmissive. In such an example, the light from the light emitter 22 travels through the optical element 46 toward the outer window 33.

For example, the optical element 46 may be or include a diffractive optical element, a diffractive diffuser, a refractive diffuser, a beam expander, a collimating lens, etc.

The light emitter 22 is aimed at the optical element 46. In other words, light from the light emitter 2 is directed by the optical element 46, e.g., by transmission through and shaping (e.g., diffusion, scattering, etc.) by the optical element 46. The light emitter 22 may be aimed directly at the optical element 46 or may be aimed indirectly at the optical element 46 through intermediate reflectors/deflectors, diffusers, optics, etc.

The optical element 46 shapes light that is emitted from the light emitter 22. Specifically, the light emitter 22 is aimed at the optical element 22, i.e., substantially all of the light emitted from the light emitter 2 hits the optical element 46. As one example of shaping the light, the optical element 46 diffuses the light, i.e., spreads the light over a larger path and reduces the concentrated intensity of the light. In such an example, the optical element 46 is a diffuser 48, e.g., a diffractive diffuser or a refractive diffuser. Light from the light emitter 22 may travel directly from the light emitter 22 to the optical element 46 or may interact with additional components between the light emitter 22 and the optical element 46. The shaped light from the optical element 46 may travel directly to the outer window 33 or may interact with additional components between the optical element 46 the outer window 33 before exiting the outer window 33 into the field of illumination FOI.

The optical element 46 directs at least some of the shaped light, e.g., the large majority of the shaped light, to the outer window 33 for illuminating the field of illumination exterior to the lidar system 20. In other words, the optical element 46 is designed to direct at least some of the shaped light to the outer window 33, i.e., is sized, shaped, positioned, and/or has optical characteristics to direct at least some of the shaped light to the outer window 33.

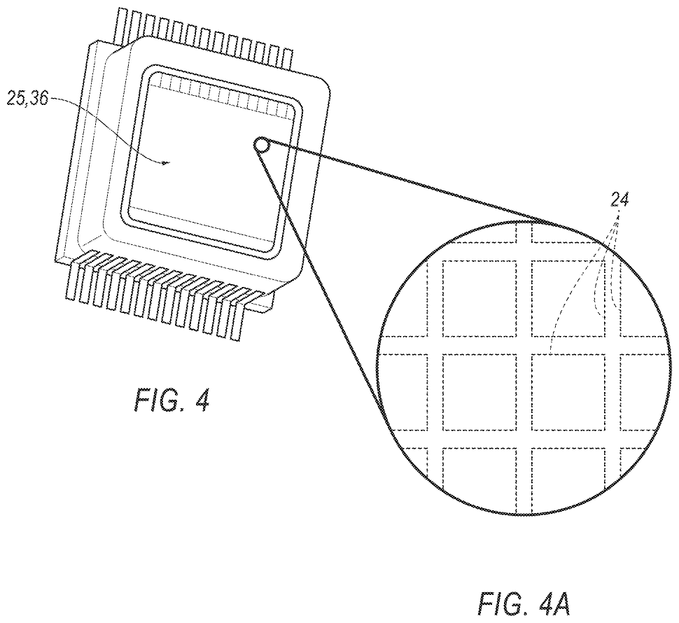

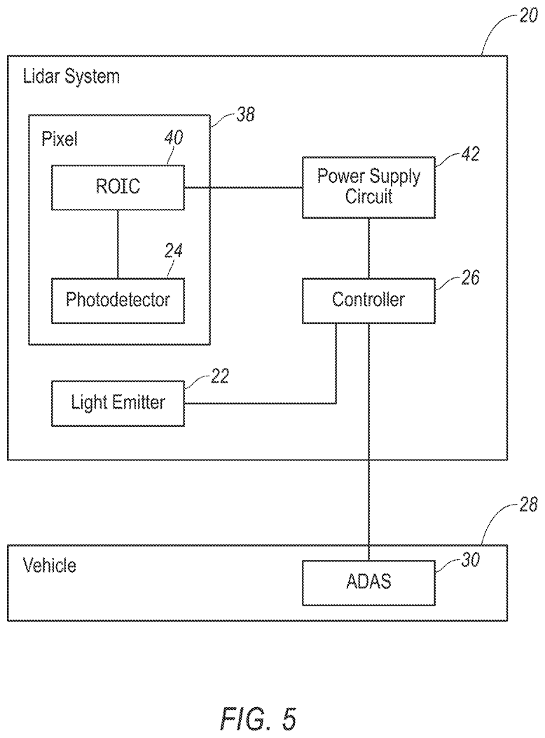

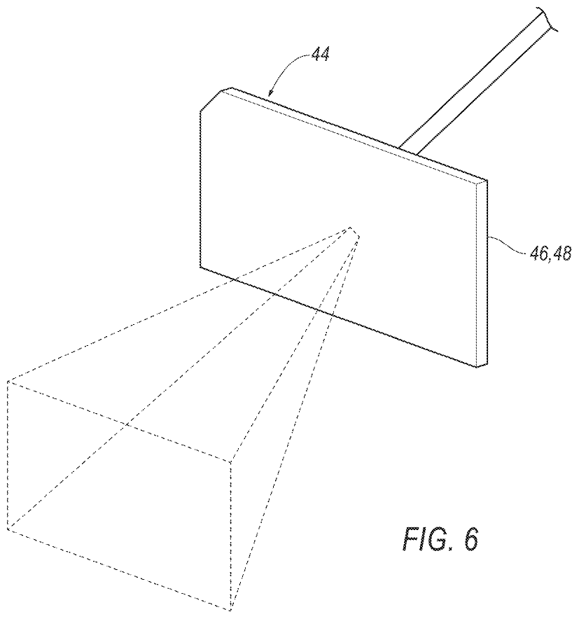

With reference to FIGS. 3-5, the light-receiving system 34 detects light, e.g., emitted by the light emitter 22. The light-receiving system 34 includes the light detector 25. The light detector 25 may include at least one photodetector 24. For example, the light detector 25 may be a focal-plane array (FPA) 36. The FPA 36 can include an array of pixels 38. Each pixel 38 can include at least one photodetector 24 and a read-out integrated circuit (ROIC) 40. A power-supply circuit 42may power the pixels 38. The FPA 36 may include a single power-supply circuit 42 in communication with all photodetectors 24 or may include a plurality of power-supply circuits 42 in communication with a group of the photodetectors 24. The light-receiving system 34 may include receiving optics 37 such as a lens package. The light-receiving system 34 may include an outer window 35 and the receiving optics 37 may be between the receiving outer window 35 and the FPA 36. The outer window 35 of the light-receiving system 34 be separate from the outer window 33 of the light-emitting system 23, as shown FIGS. 2-3, or the outer windows 33, 35 may be one piece of material. The pixel 38 may direct a time of flight measurement for each shot or may read to a histogram. In the event the pixel 38 includes multiple photodetectors 24, the photodetectors 24 may share chip architecture.

The FPA 36 detects photons by photo-excitation of electric carriers, e.g., with the photodetectors 24. An output from the FPA 36 indicates a detection of light and may be proportional to the amount of detected light. The outputs of FPA 36 are collected to generate a 3D environmental map, e.g., 3D location coordinates of objects and surfaces within FOV of the lidar system 20. The FPA 36 may include the photodetectors 24, e.g., that include semiconductor components for detecting laser and/or infrared reflections from the FOV of the lidar system 20. The photodetectors 24, may be, e.g., photodiodes (i.e., a semiconductor device having a p-n junction or a p-i-n junction) including avalanche photodetectors, metal-semiconductor-metal photodetectors, phototransistors, photoconductive detectors, phototubes, photomultipliers, etc. Optical elements of the light-receiving system 34 may be positioned between the FPA 36 in the back end of the casing 32 and the outer window 35 on the front end of the casing 32.

With continued reference to FIG. 3, the ROIC 40 converts an electrical signal received from photodetectors 24 of the FPA 36 to digital signals. The ROIC 40 may include electrical components which can convert electrical voltage to digital data. The ROIC 40 may be connected to a controller 26 of the lidar system 20, which receives the data from the ROIC 40 and may generate 3D environmental map based on the data received from the ROIC 40. The ROIC may be integrated jointly with the FPA and/or the controller 26 of the lidar system 20 into one single integrated circuit or component.

Each pixel 38 may include one photodetector 24, e.g., an avalanche-type photodetector (as described further below), connected to the power-supply circuits 42. Each power-supply circuit 42 may be connected to one of the ROICs 40. Said differently, each power-supply circuit 42 may be dedicated to one of the pixels 38 and each read-out circuit 40 may be dedicated to one of the pixels 38. Each pixel 38 may include more than one photodetector 24 (for example, two avalanche-type photodetectors).

The pixel 38 functions to output a single signal or stream of signals corresponding to a count of photons incident on the pixel 38 within one or more sampling periods. Each sampling period may be picoseconds, nanoseconds, microseconds, or milliseconds in duration. The pixel 38 can output a count of incident photons, a time between incident photons, a time of incident photons (e.g., relative to an illumination output time), or other relevant data, and the lidar system 20 can transform these data into distances from the system to external surfaces in the fields of view of these pixels 38. By merging these distances with the position of pixels 38 at which these data originated and relative positions of these pixels 38 at a time that these data were collected, the controller 26 of the lidar system 20 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

The pixels 38 may be arranged as an array, e.g., a 2-dimensional (2D) or a 1-dimensional (1D) arrangement of components. A 2D array of pixels 38 includes a plurality of pixels 38 arranged in columns and rows.

The photodetector 24 may be an avalanche-type photodetector. For example, the photodetector 24 may be operable as a single-photon avalanche diode (SPAD) based on the bias voltage applied to the photodetector 24. To function as the SPAD, the photodetector 24 operates at a bias voltage above the breakdown voltage of the semiconductor, i.e., in Geiger mode. Accordingly, a single photon can trigger a self-sustaining avalanche with the leading edge of the avalanche indicating the arrival time of the detected photon. In other words, the SPAD is a triggering device.

The power-supply circuit 42 supplies power to the photodetector 24. The power-supply circuit 42 may include active electrical components such as MOSFET (Metal-Oxide-Semiconductor Field-Effect Transistor), BiCMOS (Bipolar CMOS), etc., and passive components such as resistors, capacitors, etc. The power-supply control circuit 42 may include electrical components such as a transistor, logical components, etc. The power-supply control circuit 42 may control the power-supply circuit 42, e.g., in response to a command from a controller 26 of the lidar system 20, to apply bias voltage (and quench and reset the photodetectors 24 in the event the photodetector 24 is operated as a SPAD).

Data output from the ROIC 40 may be stored in memory, e.g., for processing by the controller 26 of the lidar system 20. The memory may be DRAM (Dynamic Random Access Memory), SRAM (Static Random Access Memory), and/or MRAM (Magneto-resistive Random Access Memory) electrically connected to the ROIC 40.

Light emitted by the light emitter 22 may be reflected off an object back to the lidar system 20 and detected by the photodetectors 24. An optical signal strength of the returning light may be, at least in part, proportional to a time of flight/distance between the lidar system 20 and the object reflecting the light. The optical signal strength may be, for example, an amount of photons that are reflected back to the lidar system 20 from one of the shots of pulsed light. The greater the distance to the object reflecting the light/the greater the flight time of the light, the lower the strength of the optical return signal, e.g., for shots of pulsed light emitted at a common intensity. A time-of-flight determination and/or histogram may be used to generate the 3D environmental map.

As set forth above, the lens 44 is positioned to project light from the light emitter 22. Specifically, the lens 44 receives light from the light emitter 22 and the lens 44 transmits the light from the light emitter 22. The light emitter 22 may be aimed directly at the lens 44 or may be aimed indirectly at the lens 44 through intermediate reflectors/deflectors, diffusers, collimators, optics, etc. As set forth above, the lens 44 may be a diffuser, e.g., diffuser 48 as shown in FIG. 3. In such an example, the lens 44 is designed to diffuse the light from the light emitter 22. As another example, the lens 44 may be an outer window, e.g., outer window 33. As another example, the lens 44 may be any suitable type of optical element that shapes, directs, and/or transmits light emitted by the light emitter 22, e.g., a diffractive diffuser, a refractive diffuser, a beam expander, a collimating lens, etc.

The lens 44 is polycarbonate. The polycarbonate may be clear. In other words, the polycarbonate without the light-absorbing dye is clear. The light-absorbing dye, when in the polycarbonate, may be clear or may be colored.

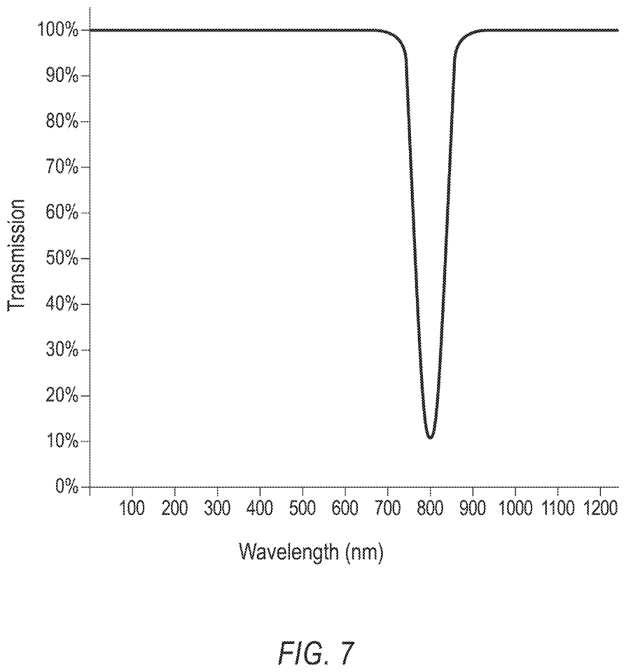

The lens 44 includes light-absorbing dye in the polycarbonate. The light-absorbing dye absorbs light having a first wavelength. For example, the light-absorbing dye may absorb light in a wavelength range, the first wavelength being in the wavelength range. Specifically, the light-absorbing dye absorbs at least a portion of the light at the first wavelength. An example is shown in FIG. 7 showing the light transmission of the light-absorbing dye at various wavelengths. As an example, as shown the example of FIG. 7, the light-absorbing dye absorbs at least a portion of the light having a wavelength within a wavelength range and transmits light having a wavelength outside of the wavelength range. Specifically, in the example in FIG. 7, the light-absorbing dye transmits approximately 10% of light at a wavelength of approximately 808 nm, i.e., the light-absorbing dye absorbs the majority of light having a wavelength of approximately 808 nm.

The light-absorbing dye transmits light at wavelengths greater than and/or less than the first wavelength. For example, the light-absorbing dye may transmit at least a portion of the light at wavelengths greater than and less than the wavelength range that is absorbed. As an example, as shown the example of FIG. 7, transmits at least a portion of the light, e.g., a majority of the light, having a wavelength outside of the wavelength range. In FIG. 7, the light-absorbing dye transmits 100% of light, i.e., does not absorb any light, having a wavelength less than approximately 750 nm or above approximately 850 nm.

As set forth above, the light emitter 22 may emit light at two different wavelengths, one being a desired wavelength and the other being an undesired wavelength. The lens 44 may be designed, i.e., with an appropriate light-absorbing dye, so that the light emitter 22 emits light in the wavelength range absorbed by the light-absorbing dye and emits light outside of the wavelength range absorbed by the light-absorbing dye. As an example, as described above, an Nd:YAG laser may emit having a wavelength between 750-850 nm (e.g., 808 nm) and light having a wavelength between 1000-1100 nm (e.g., 1064 nm). In such an example, the light-absorbing dye may be designed to absorb the light emitted by the light emitter having the wavelength between 750-850 nm and transmit the light emitted by the light emitter having the wavelength between 1000-1100 nm. In the example shown in FIG. 7, the light-absorbing dye is designed to transmit about 10% of light at 808 nm, i.e., absorbing the majority of the light at 808 nm, and is design to transmit 100% of light at 1064 nm, i.e., not absorbing any light and transmitting all of the light at 1064 nm. In this example, the “first wavelength” as described above is 808 nm. It should be appreciated that these values are provided by way of example, and the present disclosure is applicable to other values.

The light-absorbing dye may be uniformly distributed throughout the polycarbonate. As an example, the light-absorbing dye may be compounded with the polycarbonate before or during formation, e.g., molding, of the polycarbonate to the shape of the lens 44.

The light-absorbing dye may be a cyanine dye. As one example, the light-absorbing dye may be EPOLITE™ commercially available from Epolin Inc. (Newark, N.J.). Specifically, the light absorbing dye may be EPOLITE™ 5810.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A lidar assembly comprising:
a light emitter;
a light detector; and
a lens positioned to project light from the light emitter;
the lens being polycarbonate, the lens having a light-absorbing dye in the polycarbonate that absorbs light having a first wavelength and transmits light at wavelengths greater than and/or less than the first wavelength.

2. The lidar assembly of claim 1, wherein the light-absorbing dye absorbs light having a wavelength within a wavelength range and transmits light having a wavelength outside of the wavelength range, the first wavelength being in the wavelength range.

3. The lidar assembly of claiml, wherein the light-absorbing dye transmits light having a wavelength greater than and less than the wavelength range.

4. The lidar assembly of claim 1, wherein the light-absorbing dye transmits light at wavelengths greater than and less than the first wavelength.

5. The lidar assembly of claim 1, wherein the light emitter emits light in the wavelength range and light outside of the wavelength range.

6. The lidar assembly of claim 1, wherein the light emitter emits light having a wavelength between 750-850 nm and emits light having a wavelength between 1000-1100 nm, and wherein the light-absorbing dye absorbs the light emitted by the light emitter having the wavelength between 750-850 nm and transmits the light emitted by the light emitter having the wavelength between 1000-1100 nm.

7. The lidar assembly of claim 1, further comprising a casing and an outer window through the casing, wherein the lens is an optical element that shapes and/or directs light from the light emitter toward the outer window.

8. The system of claim 7, wherein the casing supports the light emitter.

9. The system of claim 8, wherein the casing supports the light detector.

10. The lidar assembly of claim 1, further comprising a casing and an outer window through the casing, wherein the lens is a diffuser that diffuses from the light emitter and directs the diffused light toward the outer window.

11. The system of claim 1, further comprising a casing, wherein the lens is an outer window through the casing that receives light from the light emitter and transmits the light exterior to the casing.

12. The system of claim 1, wherein the light-absorbing dye is uniformly distributed throughout the polycarbonate.

13. The system of claim 1, wherein the lens is designed to diffuse the light from the light emitter.

14. The system of claim 1, wherein the polycarbonate is clear.

15. The system of claim 1, wherein the light emitter is an Nd: YAG laser.
